(19) United States
(12) Patent Application Publication
(10) Pub. No.: US 2010/0267339 A1
(43) Pub. Date: Oct. 21, 2010

(54) Method for Preventing Collision and Wireless Transceiver Using the Same

(76) Inventors: Yuh-Chun Lin, Taichung County (TW); Yi-Feng Su, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/568,679

(22) Filed: Sep. 29, 2009

(30) Foreign Application Priority Data
Apr. 17, 2009 (TW) 098112827

(51) Int. Cl. H04B 15/00

(52) U.S. Cl. 455/63.1

(57) ABSTRACT

A wireless transceiver device capable of preventing collision includes a first wireless module and a second wireless module. The first wireless module includes a first wireless transceiver unit for transmitting and receiving wireless signals of a first wireless communication system, and an indication signal generating unit for generating an indication signal indicating that the first wireless transceiver unit starts to transmit or receive a wireless signal at a first time point before the first wireless transceiver unit transmits or receives the wireless signal. The second wireless module includes a second wireless transceiver unit for transmitting and receiving wireless signals of a second wireless communication system, and a transmission control unit for controlling the second wireless transceiver unit to stop transmitting or receiving wireless signals from the first time point according to the indication signal.

### BACKGROUND OF THE INVENTION

1. Field of the Invention

The present invention is related to a method for preventing collision and a wireless transceiver using the same, and more particularly, to a wireless transceiver device and method for setting a wireless module having weaker collision immune ability with higher priority over channel usage, to minimize the probability of collision, so as to enhance transmission efficiency.

2. Description of the Prior Art

With the advancement of wireless communication technology, various wireless communication systems are developed, such as mobile communication systems (GSM, 3G, LTE), wireless local area networks (Wi-fi, Wimax), wireless personal local area networks (Bluetooth, Zigbee), etc. In order to prevent interferences among the communication systems, operating frequency bands and communication techniques, such as modulation, encoding, encryption, etc., employed by the communication systems are usually different. However, under the limitation of wireless communication resources, some of the communication systems have to share the same operating frequency band, leading to an interference issue.

For example, according to protocol specifications of Bluetooth and Wi-Fi, i.e. IEEE 802.15.1 and IEEE 802.11, the operating frequency bands thereof are defined around 2.4 GHz (5 GHz employed in IEEE 802.11a) within an industrial scientific medical (ISM) band. The ISM band is world-wide reserved for industrial, scientific and medical usages, and can be utilized without permission if some regulations are followed, to prevent affecting other frequency bands. In such a situation, even though the protocol specifications, modulating methods and encoding methods of Bluetooth and Wi-Fi are different, “collision” may occur because of the same operating frequency band. “Collision” herein means that a Bluetooth (or Wi-Fi) receiver simultaneously receives Bluetooth and Wi-Fi signals, leading to operating faults.

When a Bluetooth system and a Wi-Fi system collide, the Wi-Fi system can retransmit signals to a receiver based on an automatic repeat request (ARQ) scheme and decrease a transmission rate based on a rate adaptation scheme, to increase the ratio of successful transmissions. However, compared to Wi-Fi, Bluetooth is a low-power wireless connection technique. That is, a Wi-Fi signal can easily saturate a Bluetooth receiver. In detail, when a wireless receiver receives wireless signals, an amplifier gain thereof is adjusted according to transmission conditions, to efficiently convert RF signals to baseband for operations of demodulation and decoding. In such a situation, when Bluetooth and Wi-Fi collide, the Bluetooth receiver may be malfunctioned because a received Wi-Fi signal with stronger power causes the amplifier saturated. Even worse, when collision happens, a Wi-Fi transmitter decreases the transmission rate, causing a longer transmission period of a packet, such that the probability of collision is higher, finally leading to a fatal fault.

For example, a computer system accesses internet via Wi-Fi and communicates with peripherals, such as headsets, wireless keyboard, wireless mouse, etc., via Bluetooth. When collision between Wi-Fi and Bluetooth occurs, a user can still surf internet via Wi-Fi with a lower transmission rate, but cannot use the Bluetooth peripherals, which degrades utilization convenience.

Note that, Bluetooth and Wi-Fi are taken for example since Bluetooth and Wi-Fi are usually employed in the same electronic product, such as a laptop computer, personal digital assistance (PDA), etc., such that collision is obvious and crucial. Besides, since the ISM band can be utilized without permission, other communication systems using the ISM band may induce the same collision problem. Therefore, preventing collision in an electronic device has been a major focus of the industry.

### SUMMARY OF THE INVENTION

It is therefore a primary objective of the present invention to provide a wireless transceiver device and a method for preventing collision in an electronic device.

The present invention discloses a wireless transceiver device capable of preventing collision. The wireless transceiver device comprises a first wireless module and a second wireless module. The first wireless module comprises a first wireless transceiver unit for transmitting and receiving wireless signals of a first wireless communication system, and an indication signal generating unit for generating an indication signal before the first wireless transceiver unit transmits or receives a wireless signal to indicate that the first wireless transceiver unit starts transmitting or receiving the wireless signal at a first time point. The second wireless module comprises a second wireless transceiver unit for transmitting and receiving wireless signals of a second wireless communication system, and a transmission control unit for controlling the second wireless transceiver unit to stop transmitting or receiving wireless signals from the first time point according to the indication signal.

The present invention further discloses a method for preventing collision in an electronic device. The electronic device comprises a first wireless module and a second wireless module respectively for transmitting and receiving wireless signals of a first wireless communication system and a second wireless communication system. The method comprises generating an indication signal before the first wireless transceiver module transmits or receives a wireless signal to indicate that the first wireless transceiver module starts transmitting or receiving the wireless signal at a first time point, and the second wireless module stopping transmitting or receiving wireless signals from the first time point according to the indication signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless transceiver device according to an embodiment of the present invention.

FIG. 2A and FIG. 2B are schematic diagrams of signals of the wireless transceiver device of FIG. 1 under two possible operating situations.

FIG. 3 is a schematic diagram of an operating process of the wireless transceiver device of FIG. 1.

### DETAILED DESCRIPTION

According to the present invention, a transceiver module having a weaker collision immune ability is set with higher priority to prevent collision. The “collision immune” ability herein refers to the ability that a transceiver module maintains operations when wireless signals collide, and highly depends on practical conditions, such as signal power, debugging scheme, retransmission scheme, etc. For example, if Bluetooth and Wi-Fi coexist in a system, the “collision immune” ability of a Wi-Fi transceiver module is stronger than that of a Bluetooth transceiver module. Therefore, the Bluetooth transceiver module is set with higher priority according to the present invention, i.e. the Wi-Fi transceiver module is suspended once the Bluetooth transceiver module operates. The concept is illustrated as follows.

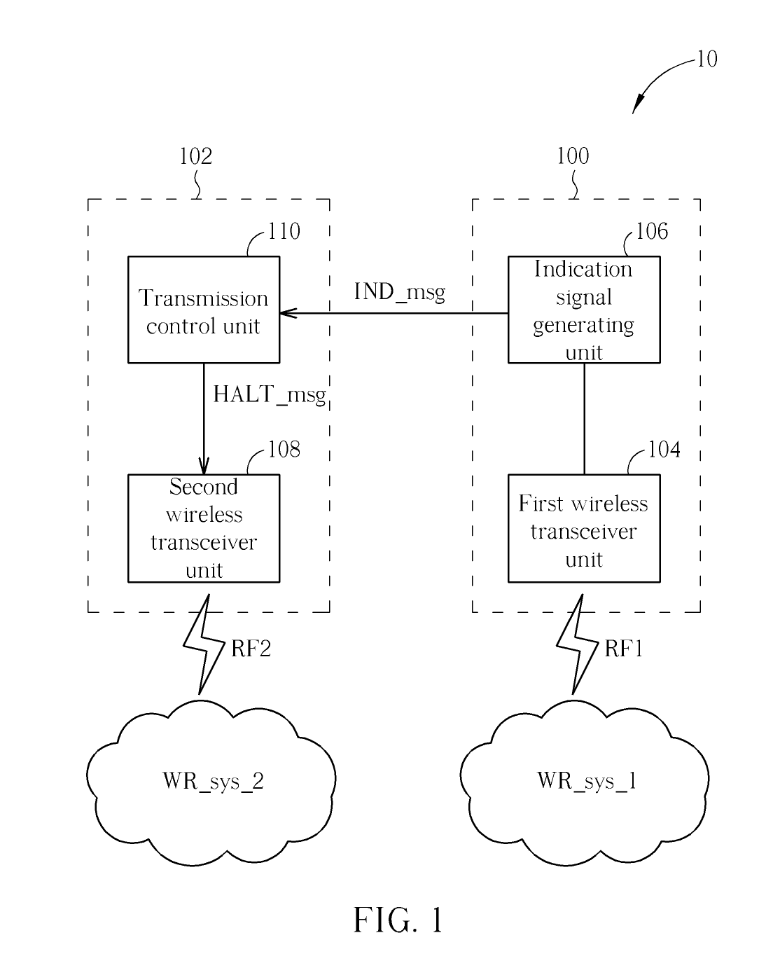

Please refer to FIG. 1, which is a schematic diagram of a wireless transceiver device 10 according to an embodiment of the present invention. The wireless transceiver device 10 can be utilized in an electronic device, such as a laptop computer, personal digital assistant (PDA), to prevent collision, and comprises a first wireless module 100 and a second wireless module 102. The collision immune ability of the first wireless module 100 is weaker than the collision immune ability of the second wireless module 102. In detail, the first wireless module 100 comprises a first wireless transceiver unit 104 and an indication signal generating unit 106. The first wireless transceiver unit 104 is utilized for transmitting or receiving wireless signals RF1 of a first wireless communication system WR_sys_1. The indication signal generating unit 106 is utilized for generating an indication signal IND_msg to the second wireless module 102, to indicate the transmitting and receiving statuses of the first wireless transceiver unit 104. The second wireless module 102 comprises a second wireless transceiver unit 108 and a transmission control unit 110. The second wireless transceiver unit 108 is utilized for transmitting or receiving wireless signals RF2 of a second wireless communication system WR_sys_2. The transmission control unit 110 is utilized for outputting a control signal HALT_msg to the second wireless transceiver unit 108 according to the indication signal IND_msg generated by the indication signal generating unit 106, to control the second wireless transceiver unit 108.

Therefore, when the first wireless transceiver unit 104 starts to transmit or receive the wireless signals RF1, the indication signal generating unit 106 generates the indication signal IND_msg to the transmission control unit 110, to indicate that the first wireless transceiver unit 104 is going to transmit or receive the wireless signals RF1 in a specific period, such that the transmission control unit 110 can suspend the second wireless transceiver unit 108 to prevent collision. In other words, since the collision immune ability of the first wireless module 100 is weaker than that of the second wireless module 102, the first wireless module 100 has higher priority over channel usage according to the present invention. That is, even if the second wireless module 102 is on duty, once the first wireless module 100 is going to transmit or receive the wireless signals RF, the second wireless module 102 has to stop operating and start or resume operating until the first wireless module 100 completes the tasks.

Note that, when the second wireless module 102 is suspended because of the first wireless module 100, since the transmission environment does not change, the transmission control unit 110 should control the second wireless transceiver unit 108 to maintain the same transmission configurations or parameters, such as transmission rate, transmission power, gain, etc., and to employ the original transmission parameters after the halt is over. In such a situation, if the second wireless transceiver unit 108 is suspended by the transmission control unit 110 before receiving a response message of a transmitted packet, the second wireless transceiver unit 108 should not decrease the transmission rate according to the rate adaptation scheme, but preferably retransmit the transmitted packet according to the original transmission parameters. In short, in the present invention, even though the first wireless module 100 has higher priority over channel usage, the transmission parameters of the second wireless module 102 remains unchanged if the second wireless module 102 is halted by the first wireless module 100, to prevent affecting transmission efficiency.

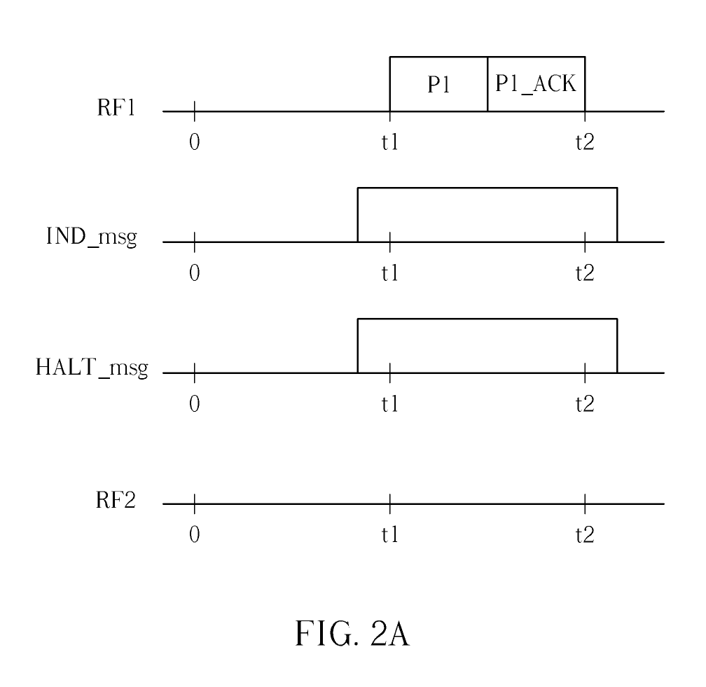

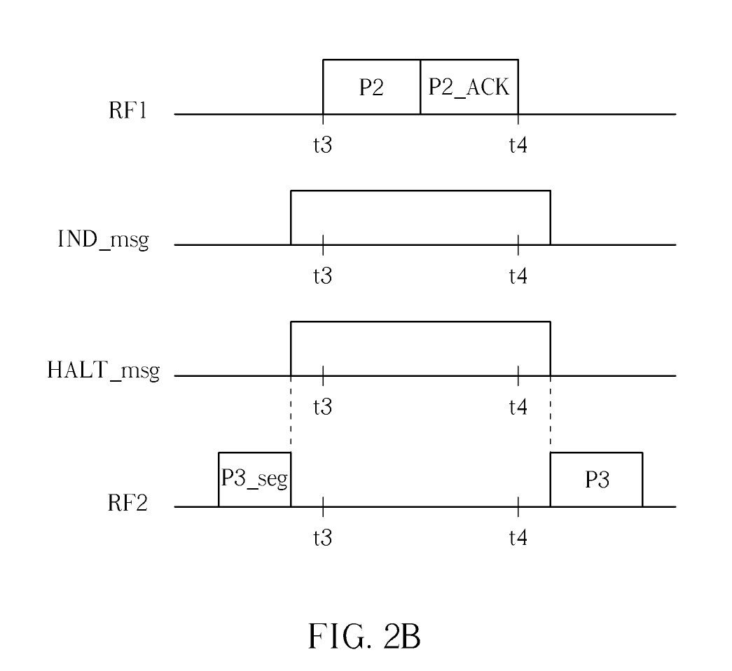

The wireless transceiver device 10 of FIG. 1 is an embodiment of the present invention, and those skilled in the art can make modifications and variations accordingly. For example, the indication signal IND_msg and the control signal HALT_msg are not limited to specific forms, as long as they can timely stop the second wireless transceiver unit 108. In detail, please refer to FIG. 2A and FIG. 2B, which are schematic diagrams of related signals of the wireless transceiver device 10 in FIG. 1 under two possible operating situations. In FIG. 2A and FIG. 2B, the indication signal IND_msg and the control signal HALT_msg are implemented by square waves. In FIG. 2A, the first wireless transceiver unit 104 transmits a packet P1 at a time point t1, and stops transmitting or receiving after receiving an acknowledgement message P1_ACK of the packet P1 at a time point t2. Thus, the indication signal IND_msg generated by the indication signal generating unit 106 rises to a high level before the time point t1, and descends to a low level after the time point t2, so does the control signal HALT_msg generated by the transmission control unit 110. In addition, in FIG. 2A, the second wireless transceiver unit 108 does not transmit any packet before the first wireless transceiver unit 104 transmits the packet P1. In comparison, in FIG. 2B, the first wireless transceiver unit 104 transmits a packet P2 and receives a corresponding acknowledgement message P2_ACK between time points t3 and t4. If the second wireless transceiver unit 108 transmits a packet P3 before the time point t3, and suspends the transmission of the packet P3 due to the indication signal HALT_msg; that is, only a segment P3_Seg of the packet P3 is transmitted. In such a situation, once the first wireless transceiver unit 104 completes transmission tasks, the control signal HALT_msg descends to the low level, such that the second wireless transceiver unit 108 can resume the transmission of the packet P3 according to the original transmission configuration.

Note that, in FIG. 2A and FIG. 2B, the indication signal IND_msg and the control signal HALT_msg are illustrated by square waves. In practical, other wave forms can be used to release the indication signal IND_msg and the control signal HALT_msg. For example, in FIG. 2A, the indication signal generating unit 106 can output a pulse signal having a first level before the time point t1, and output another pulse signal having a second level after the time point t2, i.e. the indication signal IND_msg is implemented by pulse signals having different levels. Certainly, the control signal HALT_msg can be altered in the similar manner. Besides, in FIG. 2A and FIG. 2B, widths of the indication signal IND_msg and the control signal HALT_msg are slightly greater than the operation period of the first wireless transceiver unit 104, and alternatively, the widths can exactly equal the operation period of the first wireless transceiver unit 104.

In addition, in FIG. 1, the first wireless transceiver unit 104 and the second wireless transceiver unit 108 are functional blocks, in charge of transmitting and receiving wireless signals, in the first wireless module 100 and the second wireless module 102. In practice, the first wireless transceiver unit 104 or the second wireless transceiver unit 108 may further include software, such as driving programs, and hardware, such as an antenna, mixer, modulation device, etc., and therefore, the implementation of the indication signal generating unit 106 and the transmission control unit 100 should be adjusted according to system requirements. For example, if the indication signal generating unit 106 and the transmission control unit 100 are both implemented by software, the transmission control unit 100 can passively receives the indication signal IND_msg generated by the indication signal generating unit 106, or actively check whether the indication signal generating unit 106 generates the indication signal IND_msg. The aforementioned modifications and alterations are included in the present invention, i.e. all systems, methods, etc., which set the wireless module having weaker “collision immune” ability with higher priority to prevent collision are included in the scope of the present invention.

Note that, the above embodiments use two wireless modules for example. In practice, the present invention can be applied in architectures having multiple wireless modules, i.e. to set a wireless module having the weakest collision immune ability with the highest priority. Corresponding alternations can be derived from the above description by those skilled in the art, and are not further narrated.

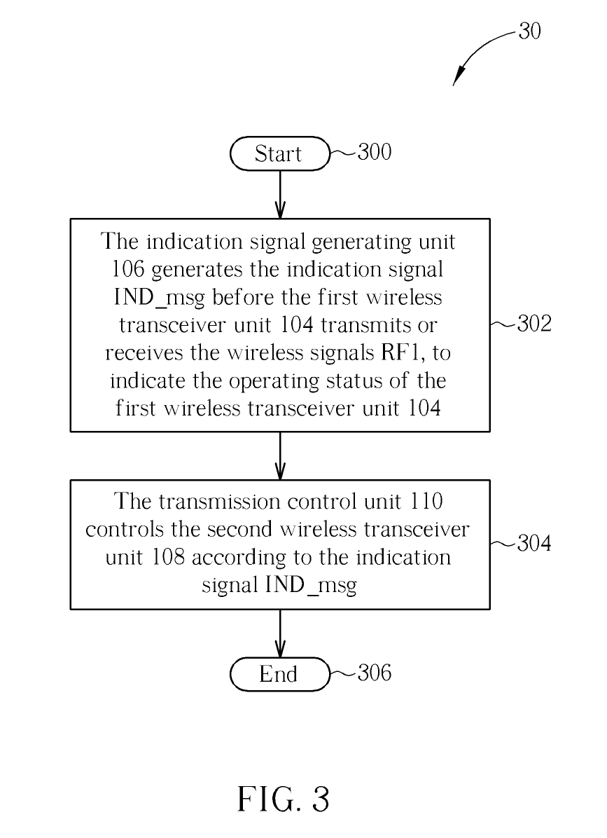

The aforementioned operations of the wireless transceiver device 10 can be summarized to a process 30, as illustrated in FIG. 3. The process 30 includes the following steps:

Step 300: Start.

Step 302: The indication signal generating unit 106 generates the indication signal IND_msg before the first wireless transceiver unit 104 transmits or receives the wireless signals RF1, to indicate the operating status of the first wireless transceiver unit 104.

Step 304: The transmission control unit 110 controls the second wireless transceiver unit 108 according to the indication signal IND_msg.

Step 306: End.

Detailed description of the process 30 can be referred in the above and not further narrated.

In the prior art, when wireless modules sharing the same frequency band collide, a wireless module having weaker collision immune ability may lose connection, causing inconvenience for users. In comparison, according to the present invention, the wireless module having weaker collision immune ability is set with higher priority over channel usage, so as to prevent collision and therefore guarantee a regular, stable transmission.

To sum up, for wireless modules sharing frequency band in an electronic device, the present invention can decrease the probability of collision, so as to enhance transmission efficiency.

Those skilled in the art will readily observe that numerous modifications and alterations of the device and method may be made while retaining the teachings of the invention.

What is claimed is:

1. A wireless transceiver device capable of preventing collision comprising:
a first wireless module, comprising:
a first wireless transceiver unit, for transmitting and receiving wireless signals of a first wireless communication system; and
an indication signal generating unit, for generating an indication signal before the first wireless transceiver unit transmits or receives a wireless signal, to indicate that the first wireless transceiver unit starts transmitting or receiving the wireless signal at a first time point; and
a second wireless module, comprising:
a second wireless transceiver unit, for transmitting and receiving wireless signals of a second wireless communication system; and
a transmission control unit, for controlling the second wireless transceiver unit to stop transmitting or receiving wireless signals from the first time point according to the indication signal.

2. The wireless transceiver device of claim 1, wherein the transmission control unit is further utilized for maintaining a transmission parameter of the second wireless transceiver unit.

3. The wireless transceiver device of claim 1, wherein the transmission control unit is utilized for controlling the second wireless transceiver unit to stop transmitting or receiving a response message corresponding to a transmitted packet from the first time point.

4. The wireless transceiver device of claim 1, wherein the indication signal generated by the indication signal generating unit is further utilized for indicating that the first wireless transceiver unit finishes transmitting or receiving the wireless signal at a second time point.

5. The wireless transceiver device of claim 4, wherein the first wireless transceiver unit receives a response message of the wireless signal at the second time point, to finish transmitting or receiving the wireless signal.

6. The wireless transceiver device of claim 4, wherein the indication signal is a square wave with a rising edge before the first time point and a descending edge after the second time point.

7. The wireless transceiver device of claim 4, wherein the transmission control unit is further utilized for controlling the second wireless transceiver unit to resume transmitting or receiving wireless signals at the second time point according to the indication signal.

8. The wireless transceiver device of claim 7, wherein the transmission control unit is further utilized for controlling the second wireless transceiver unit to resume transmitting or receiving wireless signals by a transmission parameter set before the first time point.

9. The wireless transceiver device of claim 7, wherein the transmission control unit is further utilized for controlling the second wireless transceiver unit to retransmit a non-acknowledged packet.

10. The wireless transceiver device of claim 1, wherein a wireless transmission power of the first wireless communication system is weaker than a wireless transmission power of the second wireless communication system.

11. The wireless transceiver device of claim 1, wherein the first wireless communication system is a Bluetooth system, and the second wireless communication system is a wireless local area network system.

12. A method for preventing collision in an electronic device, the electronic device comprising a first wireless module and a second wireless module respectively for transmitting and receiving wireless signals of a first wireless communication system and a second wireless communication system, the method comprising:
generating an indication signal before the first wireless transceiver module transmits or receives a wireless signal, to indicate that the first wireless transceiver module starts transmitting or receiving the wireless signal at a first time point; and
the second wireless module stopping transmitting or receiving wireless signals from the first time point according to the indication signal.

13. The method of claim 12, wherein the second wireless module stopping transmitting or receiving wireless signals from the first time point according to the indication signal comprises maintaining a transmission parameter of the second wireless module.

14. The method of claim 12, wherein the second wireless module stopping transmitting or receiving wireless signals from the first time point according to the indication signal comprises the second wireless module stopping transmitting or receiving a response message corresponding to a transmitted packet from the first time point.

15. The method of claim 12, wherein the indication signal is further utilized for indicating that the first wireless module finishes transmitting or receiving the wireless signal at a second time point.

16. The method of claim 15, wherein the first wireless module receives a response message of the wireless signal at the second time point, to finish transmitting or receiving the wireless signal.

17. The method of claim 15, wherein the indication signal is a square wave with a rising edge before the first time point and a descending edge after the second time point.

18. The method of claim 15 further comprising the second wireless module resuming transmitting or receiving wireless signals at the second time point according to the indication signal.

19. The method of claim 18, wherein the second wireless module restarting transmitting or receiving wireless signals at the second time point according to the indication signal comprises the second wireless module resuming transmitting or receiving wireless signals by a transmission parameter set before the first time point.

20. The method of claim 18, wherein the second wireless module resuming transmitting or receiving wireless signals at the second time point according to the indication signal comprises the second wireless module retransmitting a non-acknowledged packet.
